(19) United States
(12) Patent Application Publication
(10) Pub. No.: US 2016/0201598 A1
(43) Pub. Date: Jul. 14, 2016

(54) ENGINE AND ENGINE OPERATING MACHINE HAVING THE ENGINE

(71) Applicant: HITACHI KOKI CO., LTD., Tokyo (JP)

(72) Inventors: Toshinori YASUTOMI, Ibaraki (JP); Kuniyuki TSURUTA, Ibaraki (JP)

(21) Appl. No.: 14/912,335

(22) PCT Filed: Jul. 25, 2014
(86) PCT No.: PCT/JP2014/069711

§ 371 Date: Feb. 16, 2016

(30) Foreign Application Priority Data
Aug. 30, 2013 (JP) 2013-180552

(51) Int. Cl. F02F 7/00; F02B 63/02; F02F 1/00

(52) U.S. Cl. CPC F02F 7/0085; F02F 1/004; F02B 63/02

(57) ABSTRACT

An engine operating machine having a cylinder made of magnesium alloy which is excellent in weight reduction while maintaining durability of the engine is provided. The engine operating machine has: an engine having a cylinder having a piston embedded in a cylinder bore; and an operating tool driven by the engine. The cylinder is made of magnesium alloy. A nickel plating film or a copper plating film is formed on the cylinder bore or the entire of the cylinder including the cylinder bore and an outer surface of the cylinder.

### TECHNICAL FIELD

The present invention relates to such a handheld-type engine operating machine such as a chainsaw or a bush cutter that an operating tool is driven by an engine.

### BACKGROUND ART

As such an engine operating machine for mobile operation that an operating tool is driven by an engine, a chainsaw, a bush cutter, a blower, and others are cited. In the chainsaw, a saw chain which is a chain-formed saw teeth is used as the operating tool in order to cut an operation target such as a wood material. The bush cutter has a cutting blade serving as the operating tool at a tip of an operational bar, and is mainly used for grass cutting. The blower has a fan serving as the operating tool, and is used in order to blow and collect the fallen leaves or dusts on the road by using the blowing air.

In most of the handheld-type engine operating machine represented by the chainsaw and the bush cutter, not only high power of the engine and downsizing of the same but also reduction in a weight of the same are required, and therefore, aluminum alloy is employed to a cylinder of the engine. In order to further reduce the weight of the engine, it is considered that magnesium alloy having a specific gravity smaller than that of the aluminum alloy is used as a material of the cylinder.

However, the cylinder whose material is the magnesium alloy is weak in oxidization, and its strength is reduced when a temperature is 200 to 300° C., and therefore, the usage of the magnesium alloy for the cylinder of the engine used as a power source of the engine operating machine has such a problem that durability, abrasion resistance, and others of the engine cannot be sufficiently obtained.

An engine block partially using the magnesium alloy as the material of the cylinder is described in Patent Document 1. The engine block has a cylinder block main body made of magnesium alloy and a cylinder linear made of aluminum alloy, cast iron, or others, and the cylinder linear is casted into the cylinder block main body. In this engine block, in order to prevent the electric corrosion due to the contact between the cast iron and the magnesium alloy, an electric insulating layer is interposed between the cylinder linear and the cylinder block main body.

### RELATED ART DOCUMENT

### Patent Document

Patent Document 1: Japanese Patent Application Laid-Open Publication No. 2002-205158

### SUMMARY OF THE INVENTION

### Problems to be Solved by the Invention

However, when the cylinder linear made of aluminum alloy, steel material, or others is casted into the cylinder block main body, there are such problems as not only increase in a manufacturing cost of the engine block but also insufficiency of the effect of the reduction in the weight. Particularly, an operator holds the handheld-type engine operating machine such as a chainsaw in his/her hand for the operation, and therefore, the reduction in the weight of the engine is required for enhancing the workability of the engine operating machine.

An object of the present invention is to provide an engine operating machine having a cylinder made of magnesium alloy which is excellent in reduction in a weight while maintaining durability of the engine.

### Means for Solving the Problems

In an engine of the present invention having a cylinder obtained by embedding a piston into a cylinder bore, the cylinder is made of magnesium alloy, a nickel plating film or a copper plating film is formed in the cylinder bore or the entire or a part of the cylinder including the cylinder bore and an outer surface of the cylinder. The engine operating machine has an engine and an operating tool driven by the engine.

### Effects of the Invention

In this engine, the cylinder is made of magnesium alloy which is lighter than aluminum alloy, and therefore, the reduction in the weight of the engine operating machine including the cylinder can be easily achieved. The decrease in the strength of the cylinder made of the magnesium alloy cannot be avoided when a cylinder temperature is 200 to 300° C. However, by forming a nickel plating film on the cylinder bore or the entire cylinder, the cylinder strength can be increased, so that the durability of the cylinder can be improved. By forming the nickel plating film on the cylinder bore as a first layer, and then, forming a chromium plating film on a surface of the first layer as a second layer, the abrasion resistance of the cylinder bore can be also improved.

### BRIEF DESCRIPTIONS OF THE DRAWINGS

FIG. 1 is a front view illustrating a chainsaw as one example of an engine operating machine;

FIG. 2 is a cross-sectional view illustrating a part of an engine embedded into the engine operating machine;

FIG. 3 is an enlarged cross-sectional view illustrating an “A” portion of FIG. 2; and

FIG. 4 is an enlarged cross-sectional view illustrating a “B” portion of FIG. 2.

### BEST MODE FOR CARRYING OUT THE INVENTION

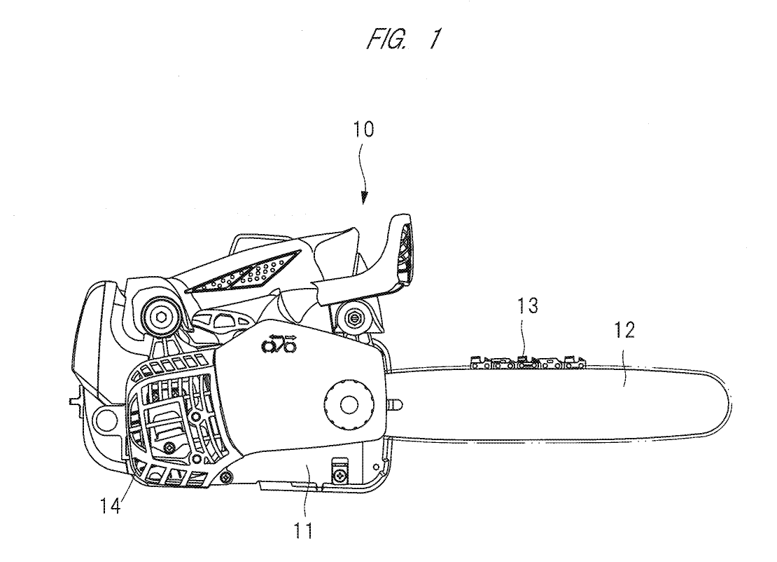

Hereinafter, embodiments of the present invention will be described in detail based on the drawings. As illustrated in FIG. 1, a chainsaw 10 serving as the engine operating machine has an operation machine main body 11. A guide bar 12 is attached to a tip portion of the operating machine main body 11, and a saw chain 13 runs around the guide bar 12. The operating machine main body 11 is provided with an engine serving as a power source although not illustrated, and a sprocket rotationally driven by a crank shaft of the engine. The saw chain 13 running around the guide bar 12 runs also around the sprocket. That is, the saw chain 13 run around a region over the sprocket and the guide bar 12, and the saw chain 13 is rotationally driven along an outer circumferential portion of the guide bar 12 by the rotational driving of the sprocket. The operator can cut or shave a target by pressing the rotating saw chain 13 onto the target such as wood.

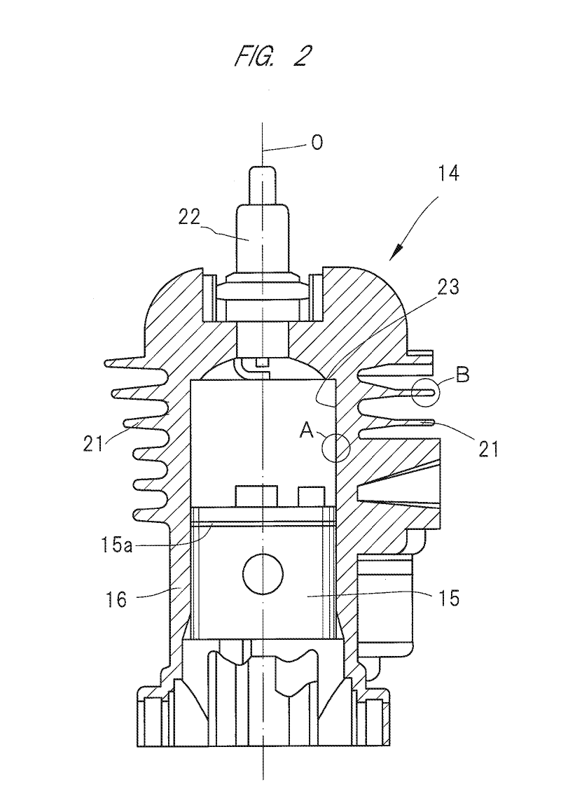

FIG. 2 is a cross-sectional view illustrating a part of the engine 14 embedded into the chainsaw 10 serving as the engine operating machine. The engine 14 has a crank case to which a crank shaft not illustrated is attached so as to freely rotate, and a cylinder 16 in which a piston 15 is embedded so as to freely linearly reciprocate, and an engine main body is formed by the crank case and the cylinder 16. The piston 15 is joined with the crank shaft by a connecting rod not illustrated, so that the reciprocation movement of the piston 15 is transformed to the rotational movement of the crank shaft.

The engine 14 is an air-cooling engine with two cycles, and a plurality of heat-release fins 21 are provided to the cylinder 16 so as to protrude outward. A carburetor is attached to the cylinder 16 through an insulator provided with a flowing path communicating with an air inlet, so that transmission of the heat of the cylinder 16 to the carburetor is prevented by the insulator.

Illustrations of the insulator, the carburetor, and others are omitted. Ambient air cleaned by a filter element and fuel from a not-illustrated fuel tank are supplied to the carburetor, mixed gas is generated by the carburetor, and the mixed gas is supplied from the air inlet to the engine main body. The supplied mixed gas is ignited by an ignition plug 22. To the cylinder 16, a muffler is attached so as to communicate with an air outlet.

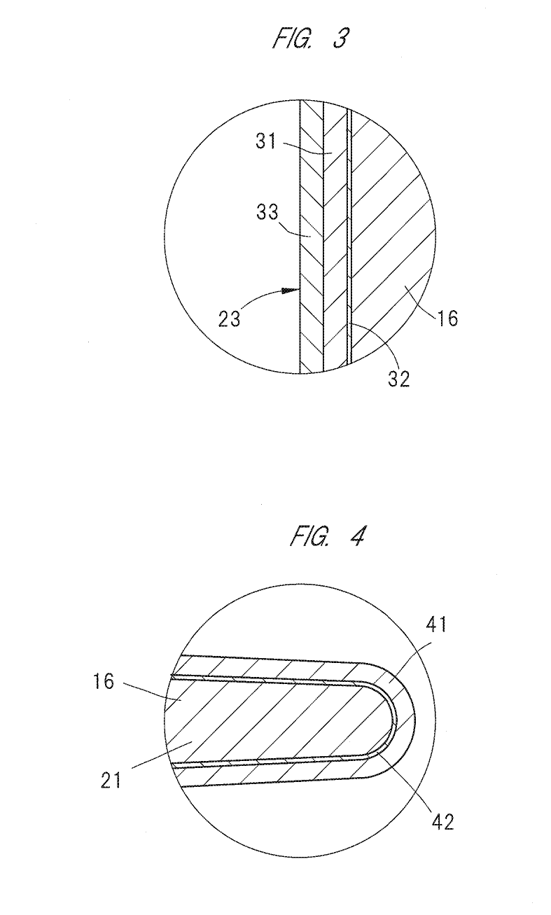

FIG. 3 is an enlarged cross-sectional view illustrating an “A” portion of FIG. 2, and FIG. 4 is an enlarged cross-sectional view illustrating a “B” portion of FIG. 2.

As illustrated in FIG. 2, a cylinder bore 23 is provided to the cylinder 16, and the piston 15 is embedded into the cylinder bore 23. The plurality of heat-release fins 21 are provided to the cylinder 16 so as to protrude outward. The cylinder 16 is manufactured by casting magnesium alloy used as a material. In the cylinder 16 casted from the magnesium alloy, the cylinder bore 23 is processed so as to have a predetermined inner diameter by machine processing. The crank case by which the crank shaft is supported so as to freely rotate is also manufactured by magnesium alloy as similar to the cylinder 16.

A specific gravity of the magnesium alloy is about ⅔ times a specific gravity of the aluminum alloy, and the weight of the cylinder 16 can be smaller than that in the case of the manufacture of the cylinder 16 by the aluminum alloy. In this manner, the weight reduction of the chainsaw 10 can be achieved. By the formation of the crankcase from the magnesium alloy as well, the weight reduction of the engine 14 configured by the cylinder 16 and the crank case can be achieved.

A nickel plating film is formed by nickel plating treatment on the entire cylinder 16 including an inner surface of the cylinder 16 including the cylinder bore 23 and an outer surface of the cylinder 16 where the heat-release fins 21 are provided. FIG. 3 illustrates a nickel plating film 31 formed on a portion of the cylinder bore 23, and FIG. 4 illustrates a nickel plating film 41 formed on surfaces of the heat-release fins 21. In FIGS. 3 and 4, note that a thickness of each of the nickel plating films 31 and 41 is illustrated so as to be inflated. The nickel plating films 31 and 41 are formed by electroless nickel plating treatment. This plating is different from electroplating, and is a treatment method for deposition of a metal nickel film on the cylinder 16 through a process of impregnation into solution by not electrons caused from energization but electrons released by oxidization of a reducing agent contained in plating solution.

The thickness of each of the nickel plating films 31 and 41 is 10 to 20 μm. By setting the thickness of each of the nickel plating films in this range, the strength of the cylinder 16 can be enhanced without loss of heat-release performance of the cylinder 16. By forming the nickel plating film on the entire cylinder 16 made of magnesium alloy, the strength of the cylinder 16 can be enhanced, and besides, oxidization of the magnesium alloy can be prevented, so that the corrosion resistance and the abrasion resistance of the cylinder 16 can be enhanced. The film formed by the electroless nickel plating treatment is subjected to a baking treatment when the temperature of the cylinder 16 increases up to 200 to 300° C., so that the strength of the film can be enhanced. In this manner, the strength of the magnesium alloy having the low strength at a high temperature is supplemented, so that the durability of the cylinder 16 can be improved. As each composition of the nickel plating films 31 and 41, nickel Ni is contained in 90 to 92%, and phosphorous P is contained in 8 to 10%. When the engine is practically driven after the assembly of the chainsaw 10, the temperature of the cylinder 16 is increased up to 200 to 300° C. by the combustion gas, so that the nickel plating films 31 and 41 are automatically subjected to the baking treatment.

In that case, when the engine is driven for about 10 minutes in combustion adjustment of the engine 14, 70% of a predetermined baking hardness is achieved in a combustion profile. By the subsequent engine driving, the rest of the hardness which is 30% can be completed. However, in a process of manufacturing the cylinder 16, the baking treatment may be performed by a thermal treatment of the cylinder 16.

Before the nickel plating films 31 and 41 are formed by the electroless nickel plating, pretreatment films 32 and 42 made of copper plating are previously formed in the cylinder 16. By the formation of the pretreatment films 32 and 42 as described above, adhesiveness between the nickel plating films 31 and 41 and the cylinder 16 can be enhanced.

As a film for enhancing the corrosion resistance and the abrasion resistance of the cylinder 16 while the strength of the cylinder 16 is maintained by preventing the oxidization of the magnesium alloy, a copper plating film may be formed over the cylinder 16 instead of the nickel plating film. A thickness of the copper plating film is 10 to 20 μm as similar to those of the nickel plating films 31 and 41. When the thickness of the copper plating film is set in this range, the strength of the cylinder 16 can be enhanced without the loss of the heat-release performance of the cylinder 16.

A piston ring 15a provided to the piston 15 slides and contacts in the cylinder bore 23. Therefore, in order to enhance an abrasion resistance of a portion in which the piston ring 15a slides, a chromium plating film 33 is formed on a surface of the nickel plating film 31 as illustrated in FIG. 3. As described above, on an inner circumferential surface of the cylinder bore 23, the nickel plating film 31 serving as the first layer and the chromium plating film 33 serving as the second layer on the surface of the nickel plating film are formed so as to be layered. When the chromium plating film is directly formed on the cylinder 16 in order to enhance the abrasion resistance of the cylinder bore 23, the cylinder 16 is corroded by chromium acid, and therefore, the chromium plating cannot be performed to the surface of the cylinder 16. On the other hand, when the chromium plating film 33 serving as the second layer is formed to be layered on the surface of the nickel plating film 31 serving as the first layer formed on the cylinder 16, the chromium plating film 33 can be formed on the surface of the cylinder bore 23, the inner circumferential surface of the cylinder bore 23 becomes the chromium plating film. In this manner, the durability and the abrasion resistance of the cylinder 16 made of the magnesium alloy can be enhanced, so that the cylinder 16 made of the magnesium alloy can be put to practical use. The inner surfaces of the cylinder 16 include not only the cylinder bore 23 in which the piston ring 15a slides but also inner surfaces of a cylinder head portion to which the ignition plug 22 is attached and an opening portion of the cylinder on the other side. Also on these inner surfaces, the chromium plating film 33 may be formed. When the chromium plating film is formed simultaneously on the entire inner surfaces, a processing efficiency can be increased.

As the second layer formed on the nickel plating film 31 serving as the first layer, an iron plating film or a nickel/silicon carbide composite (nikajiru in Japanese) plating film may be formed instead of the above-described chromium plating film 33, and both films can enhance the abrasion resistance of the cylinder bore 23.

In the cylinder 16 illustrated in FIG. 2, as illustrated in FIG. 3, the nickel plating film 31 and the chromium plating film 33 are layered on the inner surface of the cylinder bore 23. On the other hand, on an outer surface of the cylinder 16, the nickel plating film 41 is formed but the chromium plating film 33 is not formed as illustrated in FIG. 4. However, two-layered plating films may be formed on the entire of the cylinder 16, that is, on all of the inner surfaces and the outer surfaces thereof. As a film serving as the second layer in this case, any of the chromium plating film, the iron plating film, and the nickel/silicon carbide composite plating film may be formed as descried above.

The crank case is similarly made of the magnesium alloy, and the nickel plating film or the copper plating film is formed on a surface of the magnesium alloy, so that oxidization of the crank case can be prevented, and the corrosion resistance and the abrasion resistance of the crank case can be enhanced.

As described above, the specific gravity of the magnesium alloy is about ⅔ of the specific gravity of the aluminum alloy. Therefore, when the cylinder 16 is made of the magnesium alloy instead of the aluminum alloy, the weight of the cylinder 16 can be reduced, so that the weight reduction of the engine operating machine can be easily achieved. In the magnesium alloy, when the cylinder temperature during the operation of the engine is at 200 to 300° C., the decrease in the strength of the cylinder and the abrasion or oxidation corrosion of the cylinder bore 23 cannot be avoided. On the other hand, when the nickel plating film or the copper plating film is formed on the cylinder bore 23 or the entire of the cylinder 16, the strength of the cylinder 16 can be enhanced, so that the durability of the cylinder 16 can be improved.

Further, when the plating films having the two-layered structure are formed by the formation of the chromium plating film on the surface of the nickel plating film, the abrasion resistance can be improved. Therefore, when the nickel plating film 31 and the chromium plating film 33 are formed on the cylinder bore 23, the abrasion resistance of the cylinder bore 23 in which the piston ring 15a slides and contacts can be improved.

In the engine operating machine such as the chainsaw 10, after the engine 14 is stopped and the operation for the operation target is temporarily stopped, the engine 14 is restarted to continue the operation in some cases. When the engine 14 stops, the temperature of the cylinder 16 is high, and the high temperature is transmitted to the carburetor through the insulator. Therefore, when the engine stops, the mixed gas left inside the insulator and the carburetor is vapored. Therefore, when the interruption time taken until the engine restart is long, the engine cannot be smoothly restarted in some cases.

On the other hand, when the cylinder 16 is made of magnesium alloy, even if elapse of time from the engine stop is not long, the heat due to the temperature of the cylinder 16 is released and is cooled for short time. In this manner, in the engine having the cylinder 16 made of the magnesium alloy, the engine 14 can be smoothly restarted more than in the cylinder made of the aluminum alloy without the long elapsed time from the engine stop to the restart.

The present invention is not limited to the foregoing embodiments and various modifications and alterations can be made within the scope of the present invention. For example, FIGS. 1 and 2 illustrate the chainsaw 10 as the engine operating machine. However, the present invention can be applied also to other engine operating machines such as the bosh cutter as the engine operating machine as long as being such a mobile type that an operator holds it with his/her hand for the operation. Also, the illustrated engine 14 is an air-cooling two cycle engine. However, the present invention can be applied also to a cylinder of a four cycle engine.

### EXPLANATION OF REFERENCE CHARACTERS

10 . . . chainsaw (engine operating machine), 11 . . . operating machine main body, 12 . . . guide bar, 13 . . . saw chain, 14 . . . engine, 15 . . . piston, 15a . . . piston ring, 16 . . . cylinder, 21 . . . heat-release fin, 22 . . . ignition plug, 23 . . . cylinder bore, 31 . . . nickel plating film, 32 . . . pretreatment film, 33 . . . chromium plating film, 41 . . . nickel plating film, 42 . . . pretreatment film

1. An engine having a cylinder having a piston embedded in a cylinder bore,
wherein the cylinder is made of magnesium alloy, and
a nickel plating film or a copper plating film is formed on the cylinder bore, or the entire or a part of the cylinder including the cylinder bore and an outer surface of the cylinder.

2. The engine according to claim 1,
wherein the nickel plating film is formed by electroless nickel plating.

3. The engine according to claim 1,
wherein a thickness of each of the nickel plating film and the copper plating film is 10 to 20 μm.

4. The engine according to claim 1,
wherein the nickel plating film formed on the cylinder bore is formed as a first layer, and any one of a chromium plating film, an iron plating film, and a nickel/silicon carbide composite plating film is formed as a second layer to be layered on a surface of the first layer.

5. The engine according to claim 4,
wherein a pretreatment film made of copper plating having a thickness of 0.5 to 20 μm is formed on the cylinder bore before the nickel plating film serving as the first layer is formed on the cylinder bore.

6. The engine according to claim 1,
wherein a nickel plating film formed on the entire or a part of the cylinder is formed as a first layer, and any one of a chromium plating film, an iron plating film, and a nickel/silicon carbide composite plating film is formed as a second layer to be layered on a surface of the first layer.

7. An engine operating machine having the engine according to claim 1 and an operating tool driven by the engine.
